(19) United States
(12) Patent Application Publication
(10) Pub. No.: US 2012/0093113 A1
(43) Pub. Date: Apr. 19, 2012

(54) METHOD AND APPARATUS FOR REDUCING DELAY IN ESTABLISHING SESSION

(75) Inventors: Lei Zhu, Beijing (CN); Jianlin Wang, Beijing (CN); Bingzhao Li, Beijing (CN)

(73) Assignee: Huawei Technologies Co., Ltd., Shenzhen (CN)

(21) Appl. No.: 13/336,751

(22) Filed: Dec. 23, 2011

Related U.S. Application Data
(63) Continuation of application No. PCT/CN2010/074287, filed on Jun. 23, 2010.

(30) Foreign Application Priority Data
Jun. 23, 2009 (CN) 200910148039.7

(51) Int. Cl. H04W 72/04

(52) U.S. Cl. 370/329

(57) ABSTRACT

Embodiments of the present invention disclose a method and an apparatus for reducing a delay in establishing a session, relating to the field of communication technologies. The method for reducing a delay in establishing a session includes: sending a measurement report to a network control device after establishing a connection with the network control device; receiving a radio bearer reconfiguration message sent by the network control device and performing state transition to a CELL_DCH state; sending a radio bearer reconfiguration confirmation message to the network control device to notify the network control device that the state transition is completed; and receiving a session confirmation message sent by the network control device to enter into a session state.

### CROSS-REFERENCE TO RELATED APPLICATIONS

This application is a continuation of International Application No. PCT/CN2010/074287, filed on Jun. 23, 2010, which claims priority to Chinese Patent Application No. 200910148039.7, filed on Jun. 23, 2009, both of which are hereby incorporated by reference in their entireties.

### FIELD OF THE INVENTION

The present invention relates to the field of communication technologies, and in particular, to a method and an apparatus for reducing a delay in establishing a session.

### BACKGROUND OF THE INVENTION

In a VoIP (Voice over Internet Protocol, Voice over Internet Protocol) service, when a UE (User Equipment, user equipment) intends to transmit uplink data to a RNC (Radio Network Controller, radio network controller), the UE firstly needs to establish a RRC (Radio Resource Control, radio resource control) connection with the RNC, and after the connection is established, the UE may be in a variety of states such as CELL_PCH (Cell_Paging Channel) state and CELL_FACH (Cell_Forward Access Channel) state; the UE is triggered to send a measurement report to the RNC only when the data volume in the buffer of the UE exceeds a preset threshold; and after receiving the measurement report, the RNC configures a dedicated channel for the UE via a radio bearer reconfiguration message and commands the UE to perform state transition to CELL_DCH (Cell_Dedicated Channel) state.

As one of the VoIP services, the PoC (Push to Talk over Cellular, Push to Talk over Cellular) service transmits a data volume that generally requires triggering a state transition of the UE to a CELL_DCH state, but in the prior art, when the UE performs state transition to a CELL_DCH state, about 300 ms has elapsed from the moment when the user begins to speak, so the delay is too long, which greatly affects the user's experience.

### SUMMARY OF THE INVENTION

Embodiments of the present invention provide a method and an apparatus for reducing a delay in establishing a session, so as to reduce the delay in establishing the session and enhance user experience. To achieve the above objective, the embodiments of the present invention adopt the following technical solution:

An embodiment of the present invention provides a method for reducing a delay in establishing a session, including:

sending a measurement report to a network control device after establishing a connection with the network control device;

receiving a radio bearer reconfiguration message sent by the network control device, and performing state transition to a CELL_DCH state;

sending a radio bearer reconfiguration confirmation message to the network control device to notify the network control device that the state transition is completed; and

receiving a session confirmation message sent by the network control device to enter a session state.

An embodiment of the present invention provides a method for reducing a delay in establishing a session, including:

receiving a measurement report sent by a user equipment, UE;

according to the measurement report, sending a radio bearer reconfiguration message to the UE to instruct the UE to perform state transition to a CELL_DCH state;

receiving a radio bearer reconfiguration confirmation message sent by the UE; and

sending a session confirmation message to the UE to notify the UE of starting a session.

An embodiment of the present invention provides a UE, including:

a first sending module, configured to send a measurement report to a network control device after establishing a connection with the network control device;

a first receiving module, configured to receive a radio bearer reconfiguration message sent by the network control device and perform state transition to a CELL_DCH state;

a second sending module, configured to send a radio bearer reconfiguration confirmation message to the network control device to notify the network control device that the state transition is completed; and

a second receiving module, configured to receive a session confirmation message sent by the network control device to enter a session state.

An embodiment of the present invention provides a network control device, including:

a third receiving module, configured to receive a measurement report sent by a UE;

a fourth sending module, configured to send, according to the measurement report, a radio bearer reconfiguration message to the UE to instruct the UE to perform state transition to a CELL_DCH state;

a fourth receiving module, configured to receive a radio bearer reconfiguration confirmation message sent by the UE; and

a fifth sending module, configured to send a session confirmation message to the UE to notify the UE of starting a session.

With the technical solutions according to the embodiments of the present invention, a UE sends a measurement report to the network side before the UE and the network side start a formal conversation, to trigger the network side to allocate a dedicated channel for the UE, so that the UE performs state transition to a CELL_DCH state, which reduces the delay in establishing the session and enhances the user experience.

### BRIEF DESCRIPTION OF THE DRAWINGS

To illustrate the technical solutions in the embodiments of the present invention or the prior art more clearly, accompanying drawings to be used for the description of the embodiments or the prior art are briefly introduced below. Evidently, the accompanying drawings in the following description are only some embodiments of the present invention and those skilled in the art can obtain other drawings according to these drawings without creative efforts.

FIG. 1 is a flowchart of a method for reducing a delay in establishing a session according to an embodiment of the present invention;

FIG. 2 is a flowchart of a method for reducing a delay in establishing a session according to an embodiment of the present invention;

FIG. 3 is a schematic flowchart of a method for reducing a delay in establishing a session according to an embodiment of the present invention;

FIG. 4 is a structural diagram of a UE according to an embodiment of the present invention;

FIG. 5 is a structural diagram of a UE according to an embodiment of the present invention; and

FIG. 6 is a structural diagram of a network control device according to an embodiment of the present invention.

### DETAILED DESCRIPTION OF THE EMBODIMENTS

The technical solutions in the embodiments of the present invention are hereinafter described clearly and completely with reference to the accompanying drawings in the embodiments of the present invention. It is evident that the described embodiments are only a part of embodiments of the present invention, rather than all embodiments of the present invention. All other embodiments that those skilled in the art obtain without creative efforts based on the embodiments of the present invention fall within the protection scope of the present invention.

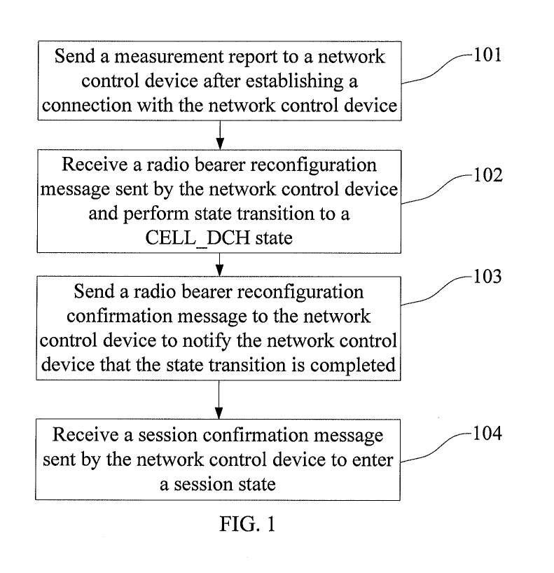

As shown in FIG. 1, an embodiment of the present invention provides a method for reducing a delay in establishing a session. The method may be used for services having a relatively large transmission data volume, such as PoC, and includes:

101: Send a measurement report to a network control device after establishing a connection with the network control device.

In the embodiments of the present invention, the network control device may be an RNC or an E-nodeB (evolved NodeB), which is not limited by the present invention; when a UE intends to send uplink data to the network side, the UE first needs to establish an RRC connection with the network control device, and after the connection is established, the UE sends a measurement report to the network control device, where the measurement report carries a buffered forecast data volume and is used for indicating to the network control device that there is upcoming uplink data to be sent and requesting allocation of dedicated channel resources for the uplink data.

102: Receive a radio bearer reconfiguration message sent by the network control device and perform state transition to a CELL_DCH state.

After receiving the measurement report, the network control device obtains the buffered forecast data volume from the measurement report and compares the volume with a preset data threshold. When the buffered forecast data volume exceeds the data threshold, the network control device immediately allocates a dedicated channel for the UE and sends a radio bearer reconfiguration message (RADIO BEARER RECONFIGURATION) to the UE to instruct the UE to transition to the CELL_DCH state.

The UE receives the radio bearer reconfiguration message, and according to the radio bearer reconfiguration message, transitions to the CELL_DCH state.

103: Send a radio bearer reconfiguration confirmation message to the network control device to notify the network control device that the state transition is completed.

104: Receive a session confirmation message sent by the network control device to enter a session state.

After receiving the radio bearer reconfiguration confirmation message, the network control device sends the UE a session confirmation message (SIP 200OK) for instructing the UE to enter the session state; the entry of the session state indicates that the service is available, and in the embodiment of the present invention, means that the user may make a conversation through the UE.

After the UE receives the session confirmation message, a formal conversation starts.

In the embodiment of the present invention, immediately after establishing a connection with the network control device, the UE sends a measurement report to the network side to request allocation of a dedicated channel for the UE to transmit uplink data. Therefore, before starting a formal conversation with the network side, the UE makes the network side allocate the dedicated channel for the UE, and performs state transition to the CELL_DCH state, which reduces the delay in establishing the session and enhances user experience.

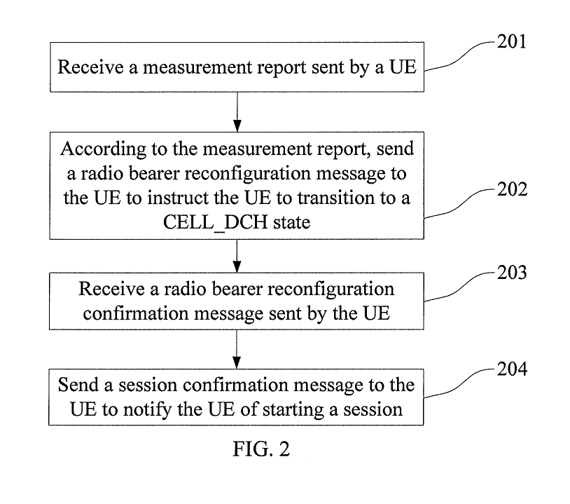

As shown in FIG. 2, an embodiment of the present invention provides a method for reducing a delay in establishing a session, including:

201. Receive a measurement report sent by a UE.

The measurement report carries a buffered forecast data volume.

202. According to the measurement report, send a radio bearer reconfiguration message to the UE to instruct the UE to perform state transition to a CELL_DCH state.

After receiving the measurement report, an RNC obtains the buffered forecast data volume and compares the volume with a preset data threshold. When the buffered forecast data volume exceeds the data threshold, the RNC immediately allocates a dedicated channel for the UE and sends a radio bearer reconfiguration message (RADIO BEARER RECONFIGURATION) to the UE to instruct the UE to transition to a CELL_DCH state.

203. Receive a radio bearer reconfiguration confirmation message sent by the UE.

After state transition to a CELL_DCH state according to the radio bearer reconfiguration message, the UE sends a radio bearer reconfiguration confirmation message to the RNC;

204. Send a session confirmation message to the UE to notify the UE of starting a session.

The RNC receives the radio bearer reconfiguration confirmation message and knows that the state transition of the UE is completed, and then sends the UE a session confirmation message (SIP 200OK) for giving a prompt that the UE may enter a session state.

After the UE receives the session confirmation message, a formal conversation starts.

In the embodiment of the present invention, before the UE and the network side start a formal conversation, the RNC instructs, according to the measurement report sent by the UE, the UE to perform state transition to a CELL_DCH state, and allocates a dedicated channel for the UE to transmit uplink data, which reduces the delay in establishing the session and enhances user experience.

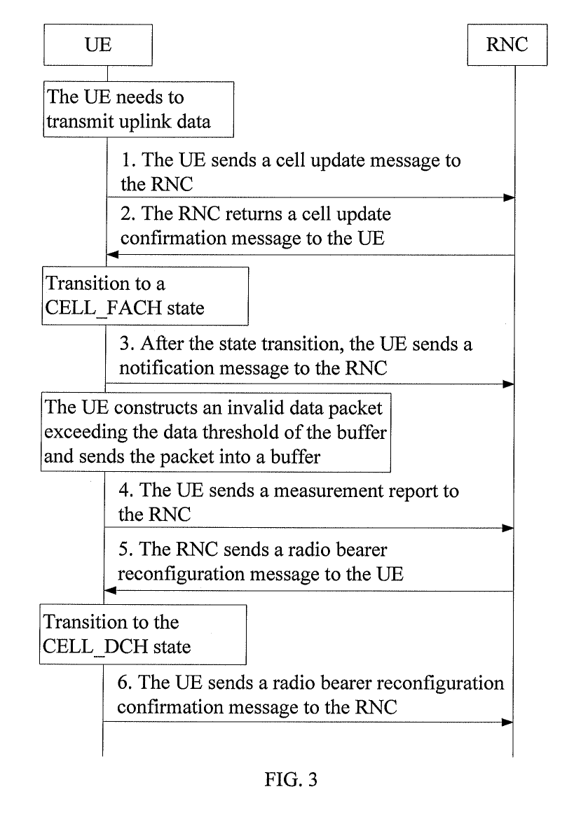

As shown in FIG. 3, an embodiment of the present invention provides a method for reducing a delay in establishing a session. The method may be used for services having a relatively large transmission data volume, such as PoC, where the following main processes of the method are as follows:

A UE sends a cell update message to an RNC.

After the UE establishes an RRC connection with the RNC, when the UE intends to send uplink data to the network side, it first sends the RNC a cell update message for notifying the RNC that the UE is to send uplink data to the RNC.

The RNC returns a cell update confirmation message to the UE.

After receiving the cell update message, the RNC returns a cell update confirmation message to the UE, commanding the UE to perform state transition to a CELL_FACH state to transmit uplink data on a common channel.

After the state transition, the UE sends a notification message to the RNC.

After receiving the cell update confirmation message sent by the RNC, the UE perform state transitions to a CELL_FACH state according to the cell update confirmation message, and after the state transition is completed, sends a notification message to the RNC to report the completion of the state transition.

The UE sends a measurement report to the RNC.

After state transition to a CELL_FACH state, the UE sends a session request message to the network side. Subsequently, the UE constructs a specific packet, where the format and/or size of the specific packet is different from that of a common voice packet, so that after receiving the specific packet, the RNC can identify and discard the specific packet, and send the specific packet to the buffer; when the data volume in the buffer exceeds a preset data threshold, the UE is triggered to send a measurement report to the RNC, where the measurement report carries the data volume in the current buffer and is used for requesting the RNC to allocate dedicated channel resources for the UE.

The RNC sends a radio bearer reconfiguration message to the UE.

After receiving the measurement report, the RNC obtains the data volume in the current buffer of the UE. Because the data volume exceeds the preset data threshold, the RNC allocates a dedicated channel for the UE and sends a radio bearer reconfiguration message to the UE to instruct the UE to transition from the CELL_FACH state to the CELL_DCH state.

The UE sends a radio bearer reconfiguration confirmation message to the RNC.

After receiving the radio bearer reconfiguration message, the UE transitions to the CELL_DCH state according to the radio bearer reconfiguration message; and after transitioning to the CELL_DCH state, the UE sends a radio bearer reconfiguration confirmation message to the RNC to notify the RNC that the state transition is completed.

After receiving the radio bearer reconfiguration confirmation message, the RNC sends the UE a session confirmation message (SIP 200OK) for giving a prompt that the UE may enter into a session state.

After the UE receives the session confirmation message, a formal conversation starts.

In the embodiment of the present invention, after state transition to a CELL_FACH state, the UE constructs a specific packet and sends the specific packet into the buffer to trigger generation of a measurement report for requesting the RNC to allocate dedicated channel resources for the UE. Therefore, before a formal conversation with the network side, the UE makes the network side allocates a dedicated channel for the UE, and performs state transition to a CELL_DCH state, which reduces the delay in establishing the session and enhances the user experience.

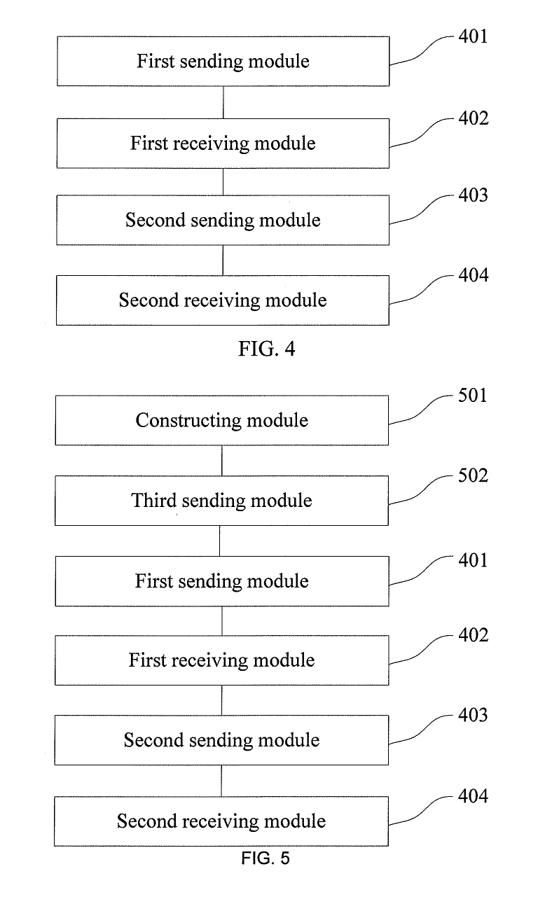

As shown in FIG. 4, an embodiment of the present invention provides a UE, including:

a first sending module 401, configured to send a measurement report to an RNC after establishing a connection with the RNC, where in the embodiment of the present invention, the measurement report carries a buffered forecast data volume;

a first receiving module 402, configured to receive a radio bearer reconfiguration message sent by the RNC and perform state transition to a CELL_DCH state;

a second sending module 403, configured to send a radio bearer reconfiguration confirmation message to the RNC to notify the RNC that the state transition is completed; and

a second receiving module 404, configured to receive a session confirmation message sent by the RNC to enter a session state.

Immediately after establishing a connection with the RNC, the UE provided by the embodiment of the present invention sends a measurement report to the network to request allocation of a dedicated channel for the UE to transmit uplink data. Therefore, before a formal conversation with the network, the UE makes the network allocate the dedicated channel for the UE, and performs state transition to the CELL_DCH state, which reduces the delay in establishing the session and enhances the user experience.

As shown in FIG. 5, an embodiment of the present invention further provides a UE, where the UE further includes:

a constructing module 501, configured to construct a specific packet, where the volume of the specific packet exceeds a preset buffered data threshold; and

a third sending module 502, configured to send the specific packet to a buffer.

After establishing a connection with the RNC, the UE provided in the embodiment of the present invention constructs a specific packet and sends the specific packet into the buffer. When the volume of the specific packet exceeds the preset data threshold, generation of a measurement report is triggered for requesting the RNC to allocate dedicated channel resources for the UE. Therefore, before a formal conversation with the network side, the UE makes the network side allocate a specific channel for the UE and performs state transition to a CELL_DCH state, which reduces the delay in establishing the session and enhances the user experience.

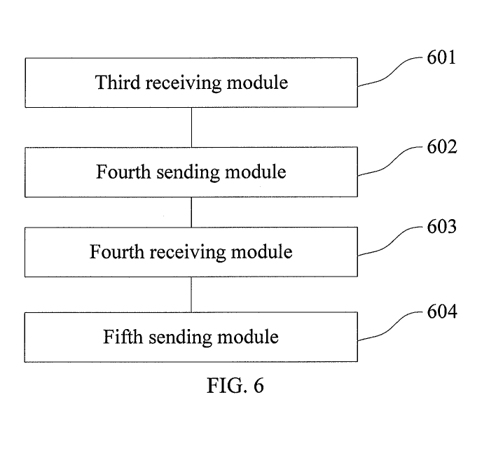

As shown in FIG. 6, an embodiment of the present invention provides a network control device, including:

a third receiving module 601, configured to receive a measurement report sent by a UE; the measurement report received by the third receiving module 601 in the embodiment of the present invention carries a buffered forecast data volume;

a fourth sending module 602, configured to send, according to the measurement report, a radio bearer reconfiguration message to the UE to instruct the UE to perform state transition to a CELL_DCH state;

a fourth receiving module 603, configured to receive a radio bearer reconfiguration confirmation message sent by the UE; and

a fifth sending module 604, configured to send a session confirmation message to the UE to notify the UE of starting a session.

The embodiment of the present invention provides a network control device, which may be an RNC or an E-nodeB; before the UE has a formal conversation with the network, the network control device instructs, according to the measurement report sent by the UE, the UE to perform state transition to a CELL_DCH state, and allocates a dedicated channel for the UE to transmit uplink data, which reduces a delay in establishing a session and enhances user experience.

Those skilled in the art may understand that all or part of steps in the methods of the above embodiments may be implemented by a program instructing relevant hardware. The program may be stored in a computer readable storage medium, such as an ROM/RAM, a magnetic disk, and an optical disk.

Detailed above are only exemplary embodiments of the present invention, but the protection scope of the present invention is not limited thereto. Any modification or substitution readily conceivable by those skilled in the art within the scope of the technology disclosed by the present invention shall fall within the protection scope of the present invention. Therefore, the protection scope of the present invention is subject to the appended claims.

1. A method for reducing a delay in establishing a session, comprising:
sending a measurement report to a network control device after establishing a connection with the network control device;
receiving a radio bearer reconfiguration message sent by the network control device and performing state transition to a Cell_Dedicated Channel (CELL_DCH) state;
sending a radio bearer reconfiguration confirmation message to the network control device to notify the network control device that the state transition is completed; and
receiving a session confirmation message sent by the network control device to enter a session state.

2. The method for reducing a delay in establishing a session according to claim 1, wherein the measurement report carries a buffered forecast data volume, wherein the buffered forecast data volume is used for indicating to the network control device that there is upcoming uplink data to be sent.

3. The method for reducing a delay in establishing a session according to claim 1, wherein before the sending a measurement report to a network control device, the method further comprises:
constructing a specific packet, wherein the volume of the specific packet exceeds a preset buffered data threshold; and
sending the specific packet to a buffer.

4. A User Equipment (UE), comprising:
a first sending module, configured to send a measurement report to a network control device after establishing a connection with the network control device;
a first receiving module, configured to receive a radio bearer reconfiguration message sent by the network control device and perform state transition to a CELL_DCH state;
a second sending module, configured to send a radio bearer reconfiguration confirmation message to the network control device to notify the network control device that the state transition is completed; and
a second receiving module, configured to receive a session confirmation message sent by the network control device to enter a session state.

5. The UE according to claim 4, wherein the first sending module is configured to send the measurement report carrying a buffered forecast data volume to the network control device after establishing a connection with the network control device, wherein the buffered forecast data volume is used for indicating to the network control device that there is upcoming uplink data to be sent.

6. The UE according to claim 4, further comprising:
a constructing module, configured to construct a specific packet, where the volume of specific packet exceeds a preset buffered data threshold; and
a third sending module, configured to send the specific packet to a buffer.

7. A network control device, comprising:
a third receiving module, configured to receive a measurement report sent by a User Equipment (UE);
a fourth sending module, configured to send, according to the measurement report, a radio bearer reconfiguration message to the UE to instruct the UE to perform state transition to a CELL_DCH state;
a fourth receiving module, configured to receive a radio bearer reconfiguration confirmation message sent by the UE; and
a fifth sending module, configured to send a session confirmation message to the UE to notify the UE of starting a session.

8. The network control device according to claim 7, wherein the third receiving module is specifically configured to receive a measurement report that is sent by the UE and carries a buffered forecast data volume.

9. The network control device according to claim 7, wherein the network control device is a RNC or an E-nodeB.
